(19) United States
(12) Patent Application Publication
(10) Pub. No.: US 2007/0020602 A1
(43) Pub. Date: Jan. 25, 2007

(54) Collecting User Responses over a Network

(76) Inventors: Andrew W. Torrance, Leawood, KS (US); William M. Tomlinson, Cambridge, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/534,890

(22) Filed: Sep. 25, 2006

Related U.S. Application Data
(62) Division of application No. 10/034,293, filed on Dec. 21, 2001.
(60) Provisional application No. 60/259,848, filed on Dec. 22, 2000.

(51) Int. Cl. G09B 7/00

(52) U.S. Cl. 434/323

(57) ABSTRACT

The disclosure includes a method of collecting user responses to questions over a network. The method includes receiving sets of data identifying a question and possible responses. The method includes sending one set of data for presentation of the question and possible responses and user selection of at least one of the possible responses. The method further includes receiving data identifying user selections of at least one of the possible responses of the set of data.

### REFERENCE TO RELATED APPLICATIONS

This application is a divisional of U.S. patent application Ser. No. 10/034,293 of Torrance et al. for Collecting User Responses Over A Network, which was filed on Dec. 21, 2001, is hereby incorporated by reference, and claims priority to U.S. Provisional Application Ser. No. 60/259,848 for Polling Systems, Methods, and Computer Programs, which was filed on Dec. 22, 2000, and is hereby incorporated by reference.

### BACKGROUND

Polling organizations, such as Gallup®, have developed a number of techniques for gauging public opinion. For example, polling organizations commonly question people on the street, phone people at home, mail questionnaires, and so forth. Most people are familiar with polls that ask voters to identify a candidate or a position that they favor. Though their polling efforts typically do not make headlines, commercial businesses also use polling techniques to discover consumer preferences regarding products, product names, prices, and so forth.

### SUMMARY

In general, in one aspect, the disclosure describes a method of collecting user responses to questions over a network. The method includes receiving from different network computers different sets of data that identify questions and possible responses. The method includes sending one of the different sets of data to different network computers for presentation of the question and possible responses and user selection of at least one of the possible responses. The method also includes receiving from the different network computers data identifying user selections of at least one of the possible responses of the one of the sets of data.

Embodiments may include one or more of the following features. The method may include sending to different network computers a different one of the sets of data for presentation of the identified question and possible responses and user selection of at least one of the possible responses. The method may further include receiving from the different network computers data identifying user selections of at least one of the possible responses of the different one of the sets of data.

The method may further include providing a user interface for user submission of a question and possible responses and/or a user interface for user selection of a response to a question.

The network may be the Internet.

The method may further include selecting a set of data for sending to a network computer. The selecting may be performed based one characteristics associated with a user operating the network computer (e.g., age, gender, income, location, and/or one or more question categories of interest) and characteristics associated with the set of data (e.g., question category, characteristics of a desired user audience, and a presence of one or more keywords in the set of data). The selecting may limit presentation of a set of data, for example, based on a number of responses to other questions provided by a submitter of the set of data.

The method may further include transmitting data associated with an advertisement to the different network computers. The method may further include selecting the advertisement. The method may further include receiving data associating the advertisement with a set of data.

The method may further include generating a report from the user selections received from the different network computers. For example, the report may show the distribution of responses selected by users for a question. Generating the report may include determining one or more correlations between characteristics associated with the set of data, characteristics of the user selections, and/or characteristics of users selecting responses (e.g., the time of response and an amount of time responses to a question were considered).

The method may further include receiving data associating different sets of data. Such data may identify a next set of data to present after user selection of one of the possible responses of a set of data.

The identification of a question may include text, an image, a sound, and a link. Similarly, identification of a possible response may include text, an image, a sound, and a link.

In general, in another aspect, the disclosure describes a method of collecting user responses to multiple-choice questions over the Internet. The method includes providing a first user interface for user submission of a question and multiple-choice responses for display via a web-browser and receiving different sets of data from different network computers presenting the first user interface. Individual ones of the sets of data include identification of a question and different multiple-choice responses to the question. The method also includes sending the sets of the data to different network computers and providing a second user interface for web-browser presentation of the question and multiple-choice responses identified by the sets of data via a web-browser. The method further includes receiving from the different network computers data identifying user selections of one of the multiple-choice responses identified by the different sets of data. The method additionally includes generating a report from the user selections received from the different network computers, the report including a distribution of responses selected by users.

In general, in another aspect, the disclosure describes a computer program product, disposed on a computer readable medium, for collecting user responses to questions over a network. The program includes instructions for causing a processor to receive from different network computers different sets of data identifying a question and possible responses to the question. The instructions also cause the processor to send to different network computers one of the different sets of data for presentation of the question and possible responses and user selection of at least one of the possible responses. The instructions also cause the processor to receive from the different network computers data identifying user selections of at least one of the possible responses of the one of the sets of data.

### BRIEF DESCRIPTION OF THE DRAWINGS

FIG. 1 is a screenshot of a user interface that receives user input specifying a question and a set of possible responses.

FIG. 2 is a screenshot of a user interface that receives user input responding to a question.

FIG. 3 is a screenshot of a report of question responses.

FIGS. 4-6 are diagrams illustrating operation of a network polling system.

FIGS. 7-9 are flowcharts of network polling processes.

FIGS. 10-12 are screenshots of an administration user interface.

### DETAILED DESCRIPTION

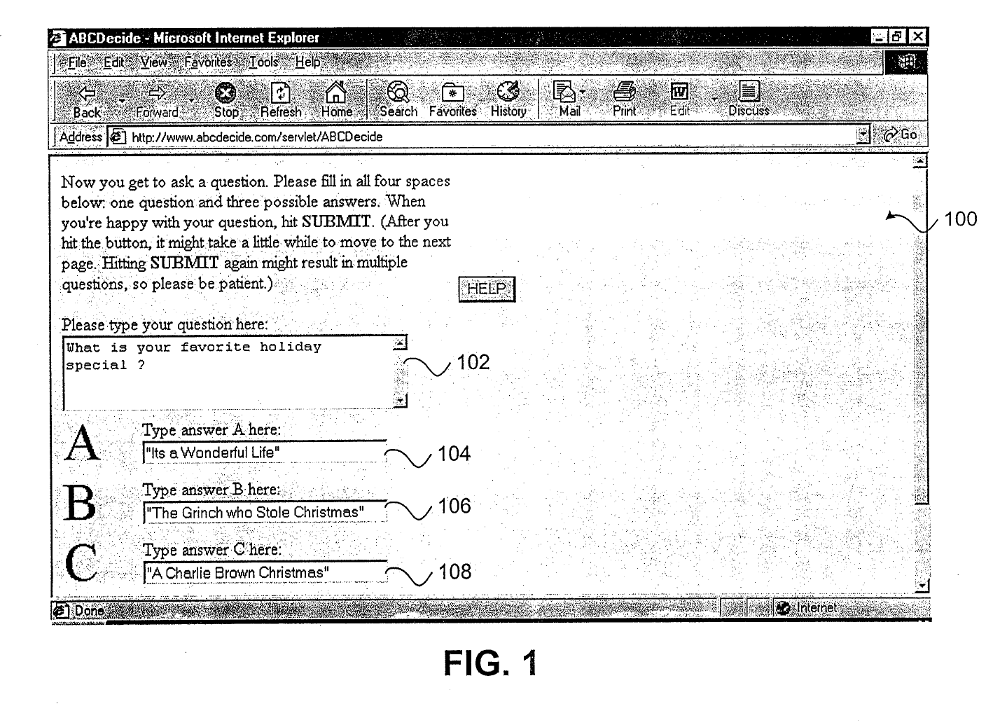

FIGS. 1 to 3 illustrate user interfaces provided by a system that enables users to conduct their own polls of network users. In more detail, the system enables users to submit a question and a set of possible responses. The system presents the submitted question and possible responses to other network users and can tabulate responses to the question. Since many users enjoy responding to questions more than they enjoy asking them, submitted questions often accumulate a large sampling of responses in short order.

While the system can provide an informal, anonymous forum for posing questions to other network users, the system can also offer businesses and organizations a variety of commercially valuable features. For example, by submitting a marketing survey question, a business can quickly glean the preferences of consumers on the Internet.

In greater detail, FIG. 1 shows a user interface 100 that enables a user to submit a question 102 and a set of possible responses 104-108. For example, as shown, the interface 100 receives user input asking “What is your favorite holiday special?” 102 and specifying a set of three different possible responses: “It's a Wonderful Life” 104, “How the Grinch Stole Christmas” 106, and “A Charlie Brown Christmas” 108. The system presents this question 102 and responses 104-108 to other network users.

The system need not restrict the subject matter of the questions. For example, users can submit advice requests, opinion polls, trivia tests, and jokes. In other embodiments, the system may filter submitted questions and responses for objectionable content and reject the question or restrict access to a suitable audience.

As used herein, the term “question” does not require a sentence including a question mark or other grammatical indicia of a question. Instead, the term “question” merely refers to text, or other presented information, prompting the possible responses. For example, instead of asking a question, a user may omit a portion of a statement and include a set of possible responses for a “fill-in-the-blank” style question. Similarly, a user may submit a statement along with a set of possible responses representing reactions to the statement.

In addition to specifying a question 102 and a set of possible responses 104-108, the user interface 100 may also collect criteria (not shown) specifying the audience for the question. For example, a user submitting a question 102 may specify a category of “Sports” or “Politics”. Other users may choose to respond to questions belonging to a particular category. Similarly, a question 102 may specify user characteristics. For example, question 102 criteria may specify a responding audience of male users between specified ages. The system may only pose the question or tabulate responses for users fitting the criteria.

As shown, the user has provided a set of three, discrete possible responses 104-108. A user can provide as few as two possible responses such as “True” and “False”. Additionally, a user interface may collect more than three possible responses.

As shown, a user can define the question 102 and set of possible responses 104-108 as text. The text can correspond to different languages (e.g., English, French, Spanish, etc.). In other implementations, users may submit graphics (e.g., images corresponding to American Sign Language), animation, sound, programs, and/or other information for presentation as the question 102 and responses 104-108. Questions 102 and responses 104-108 can also include links to other Internet sites.

The system can permit a user to build a chain of questions. For example, the response(s) selected by a user may be used to select the next question to be presented. This can be implemented in a variety of ways. For instance, a user can associate a question identifier with a particular response. When a user selects the response, the system receives the question ID and can present that question next.

To encourage users that submit questions also to respond to questions submitted by others, the system may limit the number of responses collected for a question based on the number of responses to questions provided by the submitter. For example, if a user submitting a question responds to four questions submitted by other users, the system may present the user's question four times. The limit need not be determined by a strict “one for one” scheme. Additionally, as described below, users may purchase responses to their question in lieu of responding to questions of others.

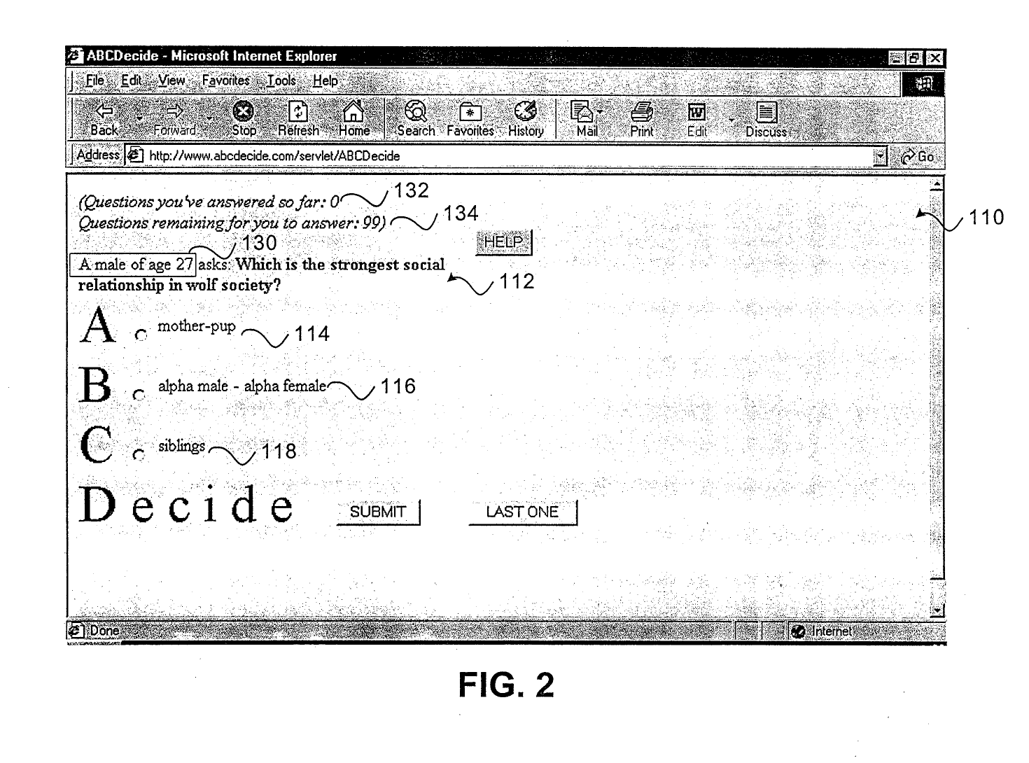

FIG. 2 shows a user interface 110 presenting a submitted question 112 and corresponding possible responses 114-118. To respond, a user selects from the set of possible responses 114-118, for example, by “clicking” on a radio-button control presented next to a response 114-118. Other user interface techniques may be used instead of a radio-button control. For example, each possible response may constitute a hyperlink having associated information identifying the response. Additionally, responses that can accept a range of values may feature a “slider”, entry field, or other user interface widgets. Further, the user interface may process input from a wide variety of sources such as a speech recognition system and so forth.

After a user submits a response, the system can select and present another question. This enables users to rapidly respond to one question after another. Many users find the process of responding to the wide variety of submitted questions both entertaining and somewhat addictive. Some users answer hundreds of questions in a relatively short time span. To keep the attention of such highly active users, the system can ensure that a user never encounters the same question twice. Because users may have submitted a question of their own, they may be more inclined to answer questions honestly, in hope of good faith within the community of users. It is also possible to pay the users, in money or some other currency of value, for their responses.

In some embodiments a user can select more than one answer or enter information such as a score for different possible responses 114-118. For example, a question may ask a user to rank different responses 114-118.

As shown, in addition to the question 112 presented, the user interface 110 may also present information 130 about the user submitting the question or other characteristics associated with the question (e.g., category). For example, as shown, the user interface 110 presents the age and gender of the submitter.

The user interface 110 shown in FIG. 2 may also include advertising such as a banner ad (not shown). A user submitting a question can supply and associate a particular ad with a particular set of question/response data. Alternatively, the system may determine an advertisement for presentation, for example, based on user characteristics, keywords included in the question 102 and responses 104-108 presented, previous responses, and so forth. Additionally, the possible responses or questions themselves may form advertisements. For example, a question may include Microsoft's slogan “Where do you want to go today?”.

Again, in some embodiments, the number of responses collected, or reported, for a submitted question depends on the number of responses provided by the submitter. As shown, the user interface 110 can notify 132 a user of the number of questions answered thus far. The user interface 110 can also indicate 134 how many unanswered questions remain in a repository of submitted questions.

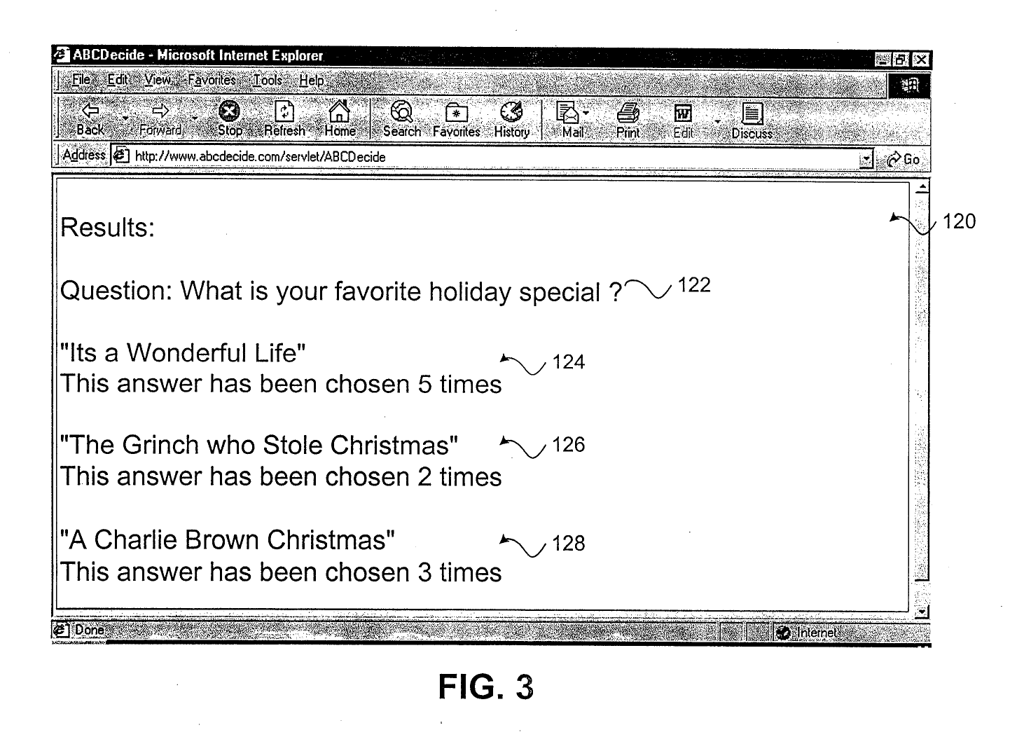

FIG. 3 shows a user interface 120 that reports a distribution 124-128 of responses collected for a question 122. The system may limit access to such a report to the user who submitted the question 122. Alternatively, the system may make the report more freely available, for example, to allow users to see how their response compares to the responses of others.

The system may provide more complex reports than the simple distribution shown in FIG. 3. For example, a report may breakdown responses by user characteristics (e.g., age and gender) and/or other information such as the time of day the system received responses, the length of time users spent on the question, and so forth. Additionally, the system may provide other analyses such as the statistical significance of the distribution. Analysis techniques such as collaborative filtering may also be used to provide predictive power with regard to answers that individuals are likely to give, based on their response history.

Other analyses such as data mining can glean further user information. Such data mining can determine and report correlations between characteristics associated with a set or sets of question/response data, characteristics of the user selections, and/or one characteristics of users selecting responses. As an example, data mining may report a correlation between the gender of a user, the time of day, and a particular response to a question.

FIGS. 1-3 depict a client web-browser, such as Microsoft® Internet Explorer®, presenting the user interfaces 100, 110, 120. The user interfaces 100, 110, 120 may be encoded in a wide variety of instruction sets/data. For example, the user interface may be encoded as HTML (HyperText Markup Language) instructions or other SGML (Structured Generalized Markup Language) instructions. The user interface 100 may also include instructions such as ActiveX components, applets, scripts, and so forth.

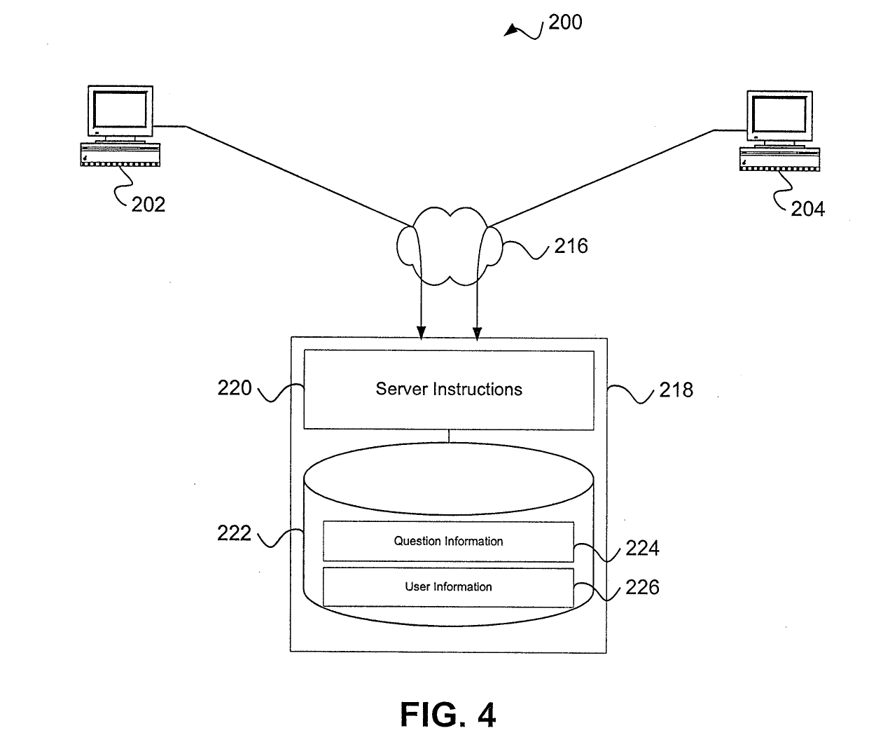

FIG. 4 illustrates an architecture 200 for implementing a network polling system. As shown, the architecture 200 includes a server 218 that communicates with clients 202, 204 at different network nodes over a network 216 such as the Internet or an intranet. Such communication may comply with HTTP (HyperText Transfer Protocol), TCP/IP (Transfer Control Protocol/Internet Protocol), and/or other communication protocols.

The server 218 includes, or otherwise has access to, storage 222 such as an SQL (Structured Query Language) or Microsoft® Access® compliant database. As shown, stored information includes question information 224 such as the submitted questions and their corresponding possible responses, identification of the submitting user, responses received thus far, the time of such responses, IP (Internet Protocol) address of a responding client, and so forth. The stored information may also include user characteristics 226 such as a username and password for each user. The user characteristics 226 may also include demographic information such as the age, gender, income, and/or location of a user. In general, the system can save a record detailing (e.g., identifying the user, time of day, user session ID, and so forth) each event that occurs (e.g., user login, question submission, presentation, and responses).

As shown, the server 218 includes instructions 220 for communicating with the clients 202, 204. For example, the server 218 may include Apache® web-server instructions that determine a URI (Universal Resource Indicator) requested by an HTTP (HyperText Transfer Protocol) request and respond accordingly. For example, in response to a received URI of “www.abcdecide.com/submitquestion,” the server 218 may transmit the form shown in FIG. 1. Similarly, in response to a received URI of “www.abcdecide.com/respond,” the server 218 may transmit the user interface shown in FIG. 2. The server 218 may also include CGI (Common Gateway Interface) and/or Perl instructions for processing information received from the clients 202, 204.

The instructions 220 also include polling logic. That is, the instructions 220 can store the submitted question, select a question for presentation to a user, process a received response to a question, and so forth.

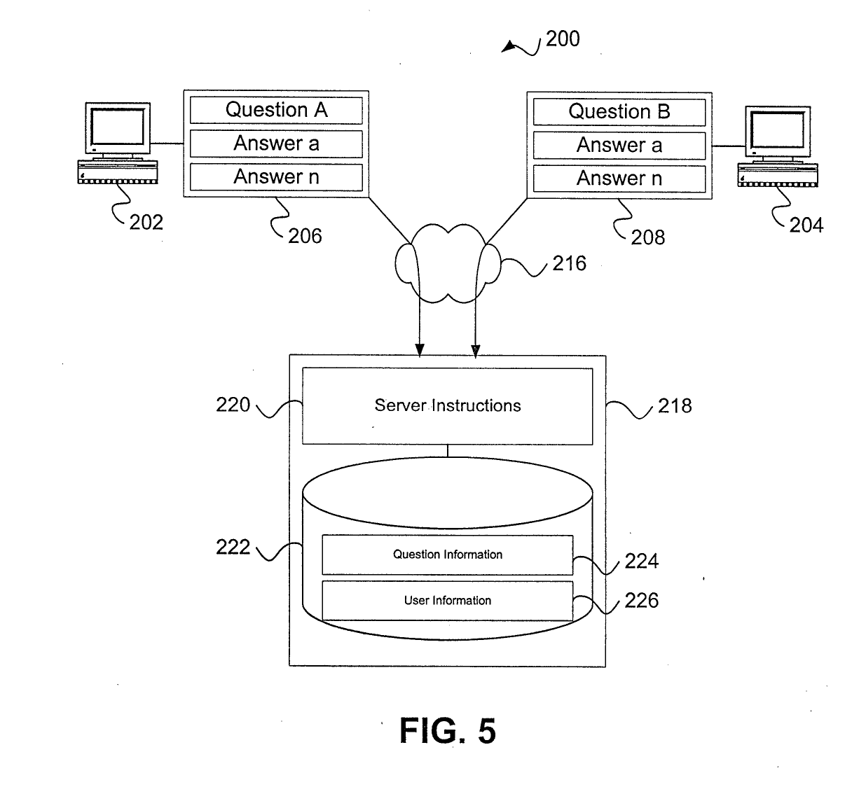

As shown in FIG. 5, the architecture 200 enables users at different clients 202, 204 to submit questions and possible responses to the server 218. For example, the server 218 may transmit user interface instructions for a form, such as the form shown in FIG. 1, that enables a user to specify a question and a set of possible responses. The user interface instructions transmit the collected information 206, 208 back to the server 218, for example, as URI parameters (e.g., “www.abcdecide.com/cgi/?question-What is your favorite color+?response1=red+?response2=blue+?response3=green). Again, the server 218 can store the received question and possible responses along with other information such as identification of a user submitting the question, the time of submission, a session ID of the user submitting the question, and so forth.

Before the server 218 allows a user to submit a question, the server 218 may request submission of user information, for example, identifying a username, password, age, gender, zipcode, and so forth. The user can use the username and password to identify the user to the server 218, for example, at a later session, potentially, initiated at a different network computer. The system can request contact information (e.g., an e-mail address) from users if they would like to be notified of certain events, such as when their submitted question has received a requested number of answers.

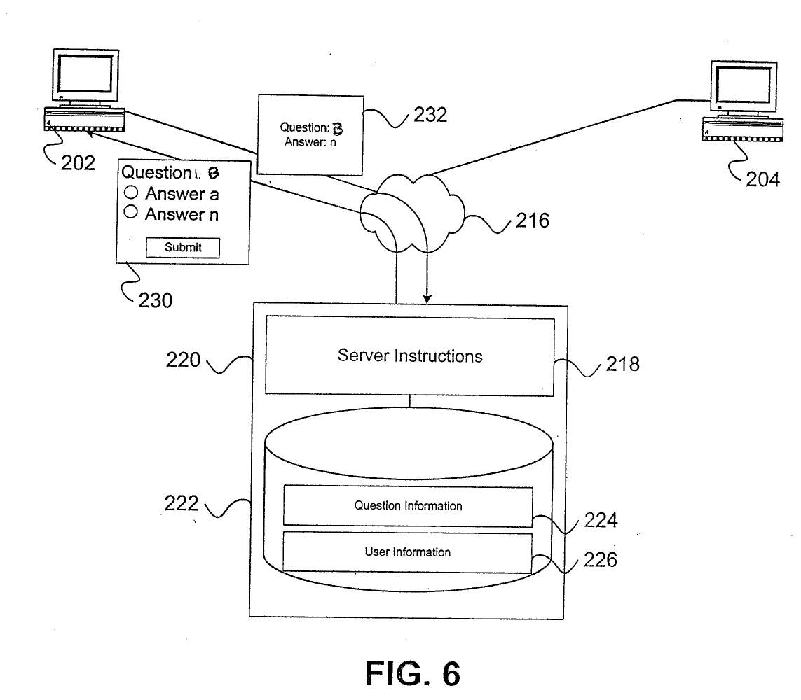

As shown in FIG. 6, the server 218 can select and present a submitted question 230 to a user operating a client 202. For example, as shown, the server 218 selected a question submitted by a user operating client 204. The server 218 can select a question, for example, based on a question category identified by a user responding to questions.

The server 218 can select questions such that a user does not answer the same question twice. For example, each question may receive an identifier generated by incrementing a question counter. In such an embodiment, the server 218 can select a question to present to a user by determining the identifier of the last question answered by the user and adding one. The server 218 may store the identifier of the last question presented in the database of user information 226. This enables the server 218 to determine the most active users. This information can enable the system to produce a report that isolates responses of the most active users. Alternatively, the server 218 may store a “cookie” at a user's client that includes the identifier of the last question presented.

Similarly, the system may ensure that user does not have to answer questions that he himself posed. For example, the system can compare the username associated with the current session with the username of the user that originally submitted the question.

When selecting a question, the server 218 may skip questions where the user does not satisfy question criteria specified by a question submitter. Similarly, the server 218 may skip a question to limit the number of responses collected.

After selecting a question to present to a user, the server 218 can dynamically construct a user interface including the question and the question's set of possible responses. For example, the server 218 may include PHP (Personal Home Page) instructions that dynamically generate HTML (HyperText Markup Language) instructions. The server 218 can then transmit the generated instructions to the user's client 202.

In another embodiment, instead of dynamically generating instructions for each question at the server 218, the user interface instructions transmitted to a client may include an applet that communicates with the server 218, for example, using JDBC (Java Database Connectivity). The applet can transmit a response to the current question and query the server 218 for the next question. The applet then reconstructs the screen displayed by the user interface to present the next question. Other embodiments feature a Java servlet which is run when a user accesses the service. Other techniques for handling client/server communication over the Internet are well known in the art and may be used instead of the techniques described above.

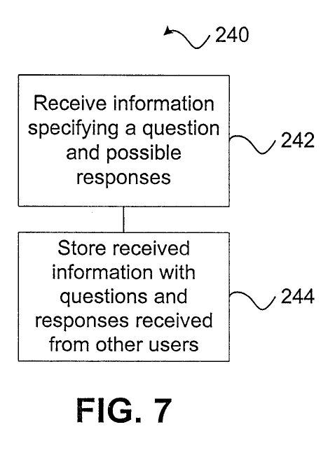

FIGS. 7-9 are flowcharts of network polling processes. FIG. 7 depicts a flowchart of a process 240 for receiving questions submitted by users. As shown, the process 240 receives information specifying a question and a set of possible answers. For example, the process 240 may transmit user interface instructions, such as the form shown in FIG. 1, that receive and transmit user input over a network. The process 240 stores 244 the received question and possible responses along with questions and possible responses received from other users. The process 240 may limit the number of active questions a particular user may submit.

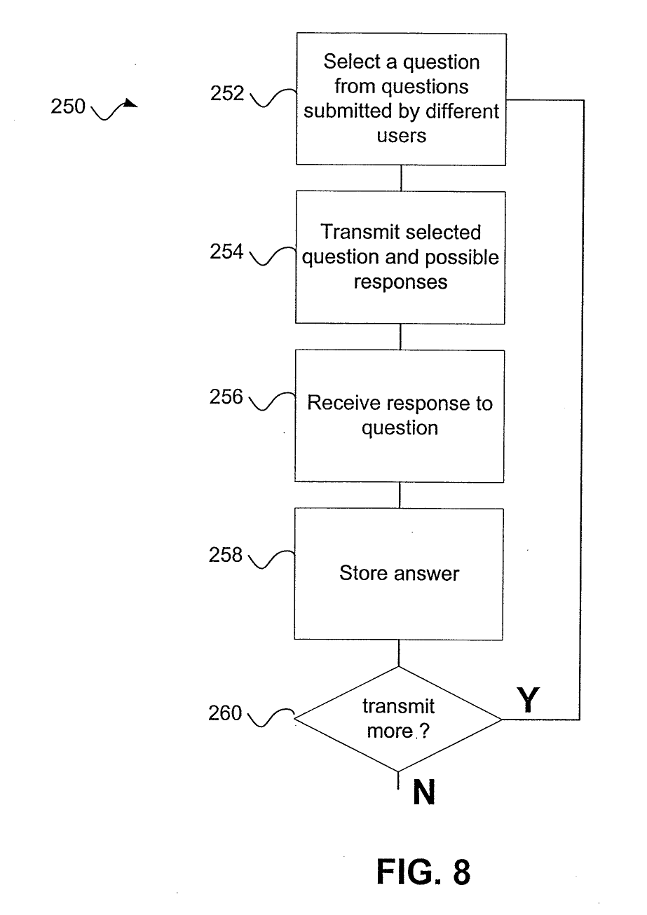

FIG. 8 depicts a flowchart of a process 250 for collecting and tabulating responses to submitted questions. As shown, the process 250 selects 252 a question from the different questions submitted by different users. The process 250 transmits 254 the selected question and possible responses to a network client. The process 250 then receives 256 and stores 258 the user's response. The process 250 can repeat 260 depending on the number of questions the user chooses to answer.

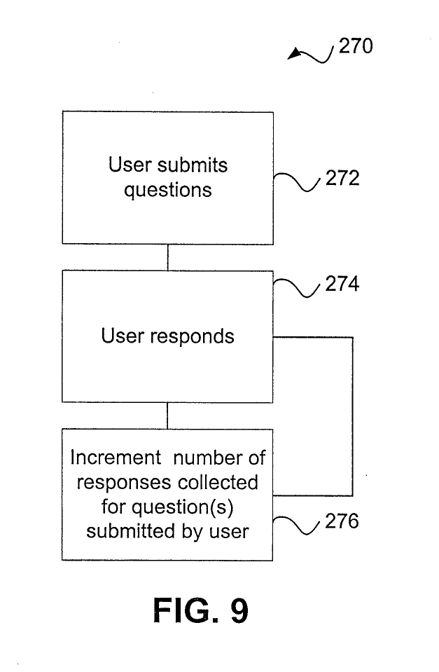

FIG. 9 depicts a flowchart of a process 270 for limiting the number of responses collected and/or reported for a submitted question. As shown, after a user submits 272 a question, the process 270 presents questions submitted by others. Each response 274 to a question submitted by another increments 276 the number of responses collected and/or reported for the user's submitted question.

If a user has more than one outstanding question the system may distribute the responses collected and/or reported across the different questions. For example, the system can increment the number of responses collected for the most recently received question. Alternatively, the user can identify which of the various outstanding questions is incremented. As yet another alternative, the system can spread responses evenly across each outstanding questions.

The system as described and shown has a wide variety of potential applications. For example, the system may simply be an entertaining diversion for web-surfers. The system, however, can also provide valuable marketing information. For example, the system may use the user's identity, questions posed and responses given, as well as other accessible information (e.g., life habits based on accessing times of the site) to discover correlations, for example, all answers to questions that have ever involved a certain keyword, all answers given by a single user, demographic breakdowns of site access time, and so forth.

Instead of analyzing the data, the information collected may be provided to market researchers for their own determination of trends and consumer attitudes. Since the system can enable users to select their own username, making such information available need not compromise the anonymity of users responding to questions.

The system may also receive questions on behalf of commercial clients. This enables commercial clients to conduct their surveys unobtrusively. A survey question from a commercial client can appear in the midst of questions submitted by non-commercial users. The questions of the commercial client can escape detection as market research and, potentially, avoid problems associated with more traditional market research such as the bias introduced when a consumer knows they are subject of a marketing effort. In addition to candid responses, the system can provide commercial clients access to a large, diverse user base and can enable the clients to conduct rapid surveys that yield highly-relevant (e.g., demographically targeted) and cost-effective results (e.g., small fee per response).

Site administrators may charge commercial clients for responses. For example, a commercial client may purchase a specified number of responses to a question for a fee. Alternatively, a commercial client may purchase a “time period” for the system to collect responses. The administrators may also enable specification of the position the questions is presented. For example, a commercial client may pay to have their question presented within the first four presented to each user or to have their questions presented in a particular order or separated by a specified number of other questions.

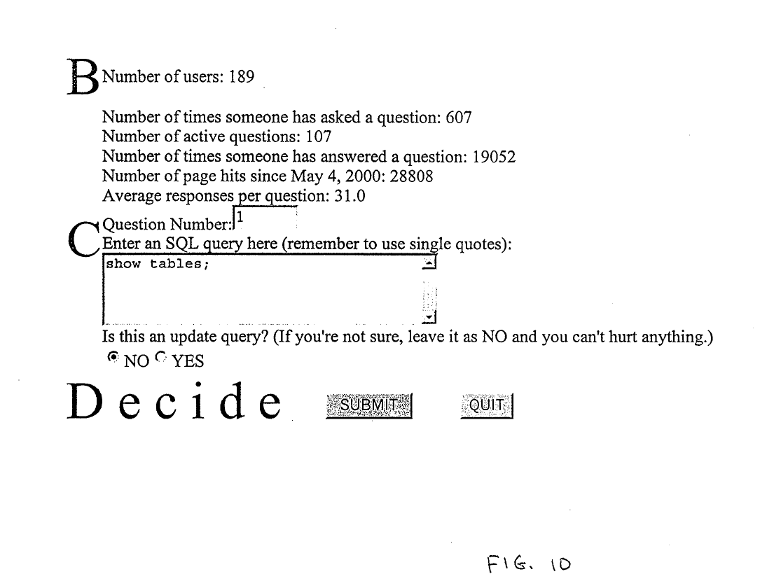

FIGS. 10-12 illustrate screenshots of a network-based tool for system administration. The tool enables an administrator to view results, access and manipulate stored information, test system features, masquerade as a particular user, and so forth.

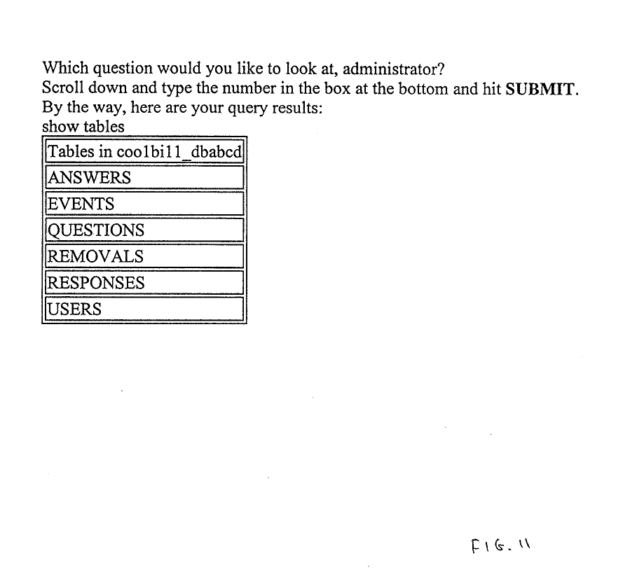

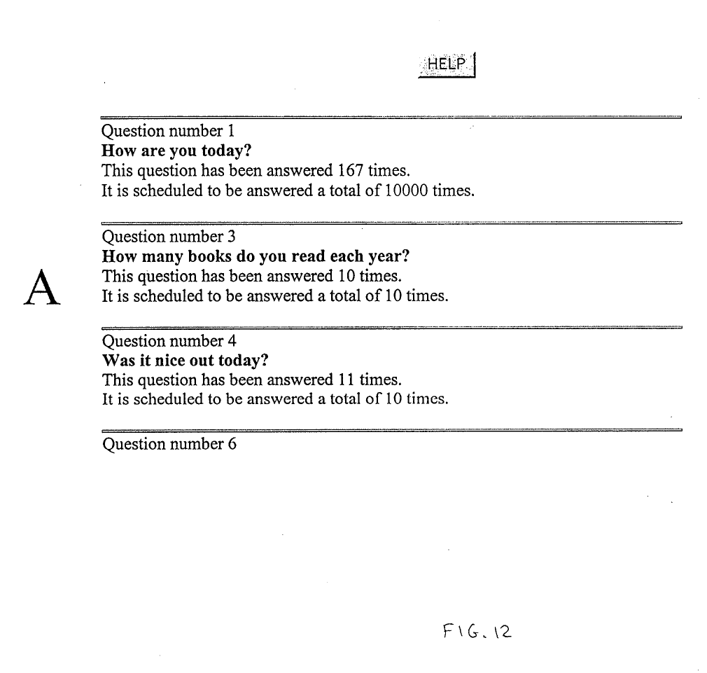

As shown in FIG. 10, the tool permits an administrator to submit SQL commands and queries to retrieve and modify stored information. For example, as shown a user has entered a “show tables” command into the SQL window. FIG. 11 shows the results of this command. As shown in FIG. 12, the tool can also present an administrator with a list of questions asked, how many responses have been received, and so forth.

In other embodiments, the system may offer functionality by which different kinds of users, (e.g., administrators, power users, guests, etc.) may perform different, more elaborate or simpler, queries, or pose different kinds of questions (e.g., with different numbers of possible responses), manipulate stored information (e.g., information about other users, etc.) and so forth.

The system may also provide games and other elaborations, for example by keeping score, or by enabling users to predict the results that their questions will receive, or by giving out awards or prizes for satisfying various criteria.

The system can automatically generate questions and pose them through the service, and then proactively offer the results to a company. For example, a question might be “Which N do you prefer?” and three responses “X”, “Y”, and “Z”, with N being a category like “web browser” and X, Y, and Z being examples of that category—“Microsoft® Internet Explorer®”, “Netscape® Navigator®,” “neither.” The content for these automatically generated questions could be derived from a variety of sources (e.g., a database, a software-selling web site with product categories and specific products listed in an accessible format). Various entities might be interested in this data (e.g., the software seller, the makers of the products, market researchers and so forth).

While illustrated as a web-based system, the techniques described herein may be used with a wide variety of communication networks and devices such as WAP-enabled (Wireless Applications Protocol) devices, PDAs (Personal Digital Assistants), wearable computing devices, and so forth.

The techniques described herein are not limited to a particular hardware or software configuration; they may find applicability in a wide variety of computing or processing environments. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be compiled or interpreted language. Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein The system may also be considered to be implemented as a computer-readable storage medium, configured with a computer program, where the storage medium so configured causes a computer to operate in a specific and predefined manner.

What is claimed is:

1. For collecting user responses to questions over a network, a method comprising:
A) using a server to:
i) send over the network, to a first user, signals that identify one or more other-user questions that the server has received over the network from one or more users other than the first user; and
ii) receive over the network, from the first user, signals that identify a response to each of one or more of the other-user questions; and
B) using the server to:
i) receive over the network from the first user one or more first-user questions to be posed over the network to users other than the first user and
ii) send to the first user over the network response information determined by one or more first-user-question responses received over the network by the server from users other than the first user in response to the server's transmitting one or more of the first-user questions over the network to those other users
in such a manner that the number of first-user-question responses by which the response information is determined depends at least in part on how many responses to other-user questions the server has received over the network from the first user.

2. The method of claim 1, wherein at least some of the other-user questions that the server sends the first user are questions that the server has selected in accordance with one or more keywords in the other-user questions or possible answers thereto.

3. The method of claim 1 wherein the first-user questions are so identified by the signals sent by the server that one or more of the first-user questions and/or possible responses thereto include advertisements.

4. The method of claim 1 further comprising generating a report based on one or more correlations between amounts of time responses to the first-user questions were considered and at least one of the following: one or more characteristics associated with the set of data, one or more characteristics of the user selections, and one or more characteristics of users selecting responses.

5. The method of claim 1 wherein the signals that identify the other-user questions direct a browser running on the first user's computer to display one or more other-user questions that the server has received over the network from one or more users other than the first user in such a manner that a hyperlink is included in at least one said other-user question.

6. The method of claim 1 wherein the signals that identify the other-user questions additionally identify possible responses to at least one said other-user question and direct a browser running on the first user's computer to display one or more said possible responses in such a manner that it includes a hyperlink.

7. A method as in claim 1 further comprising using the server to send the first user signals that identify possible answers to the user questions.

8. For collecting user responses to questions over a network, a method comprising:
A) using a server to send over the network, to a first user, signals that direct a browser running in the first user's computer to display one or more other-user questions, which the server has received over the network from one or more users other than the first user, in such a manner that a hyperlink is included in at least one said other-user question or proposed response thereto; and
B) using the server to:
i) receive over the network from the first user one or more first-user questions to be posed over the network to users other than the first user; and
ii) send to the first user over the network response information determined by one or more user-question responses received over the network by the server from users other than the first user in response to the server's transmitting over the network to those other users signals that identify one or more of the first-user questions.

9. For collecting user responses to questions over a network, a method comprising:
A) using a server to send over the network, to a first user, signals that identify one or more other-user questions, which the server has received over the network from one or more users other than the first user; and
B) using the server to:
i) receive over the network from the first user one or more first-user questions to be posed over the network to users other than the first user;
ii) transmit over the network to such other users signals identifying one or more of the first-user questions such that the user questions and/or possible responses thereto include advertisements;
iii) receive over the network from such other users signals that identify responses to one or more of the first-user questions; and
iv) send to the first user over the network response information determined by the responses thereby identified.

10. For collecting user responses to questions over a network, a method comprising:
A) using a server to:
i) send over the network, to a first user, signals that identify one or more other-user questions that the server has received over the network from one or more users other than the first user; and
ii) receive over the network, from the first user, signals that identify a response to each of one or more of the other-user questions; and
B) using the server to:
i) receive over the network from the first user a plurality of first-user questions to be posed over the network to users other than the first user;
ii) select from among the first-user questions in accordance with keywords contained in those questions and/or proposed answers thereto;
iii) send over the network, to at least one user other than the first user, signals that identify the first-user questions thus selected; and
iv) send to the first user over the network response information determined by one or more first-user-question responses received over the network by the server from such other users in response to the selected first-user questions.
